(19) United States
(12) Patent Application Publication
(10) Pub. No.: US 2020/0286167 A1
(43) Pub. Date: Sep. 10, 2020

(54) System and Method of Analysis based on Social Media

(71) Applicants: Sean Malek, Las Vegas, NV (US); Lisa A. Malek, Las Vegas, NV (US); Corey Malek, Las Vegas, NV (US); Brandon Malek, Las Vegas, NV (US); Troy Allen Rhett, Las Vegas, NV (US)

(72) Inventors: Sean Malek, Las Vegas, NV (US); Lisa A. Malek, Las Vegas, NV (US); Corey Malek, Las Vegas, NV (US); Brandon Malek, Las Vegas, NV (US); Troy Allen Rhett, Las Vegas, NV (US)

(21) Appl. No.: 16/297,226

(22) Filed: Mar. 8, 2019

(51) Int. Cl. G06Q 40/02; G06Q 50/00; G06Q 30/08; G06Q 30/02; G06Q 30/06; G06Q 30/00

(52) U.S. Cl. CPC G06Q 40/025; G06Q 50/01; G06Q 30/0185; G06Q 30/0278; G06Q 30/0609; G06Q 30/08

(57) ABSTRACT

To have a mechanism to reduce or avoid problems for lending/borrowing from/to family/friends, we have presented a system and method here, called StreetCred, or SC. This can be applied to money, cash, bitcoin, cryptocurrency, credit line, or the equivalents, as well as other objects, such as cars, jackets, and other personal items. The ratings and scores are based on social networks, e.g., based on reputation and reliability of a user. The score can supplement the FICO score or similar scores. It can help regular banks or credit cards, as well. The initial circle of family/friends can be extended later on, to a 3^{rd} party, for any object/item. The reputation and reliability score is very universal and can help other areas of commerce or e-commerce, as well. It encourages and rewards good and on-time behavior and common-sense/courtesy between people/family/friends. Many examples and variations are presented here.

### BACKGROUND

Recently and for the past 20 years, people have used social media for many purposes, e.g., for auction online, e.g., e-Bay, where score given by/from other users can validate/improve or ruin somebody's reputation and status on the website/e-commerce, for future transactions. So, that would self-police the behavior of people, so they behave in good faith for transactions, as any negative feedback for a past transaction will affect the future transactions, or chance of survival of the business on that site, negatively, and that encourages people to be fair and professional, because one cheating incidence or bad behavior can prevent/reduce future transactions.

The banks or credit cards rely on the FICO scores or similar metrics to approve the loans and gauge the reliability and status of people for financial or loan settings. However, for micro-loans or fast loans between friends/family, currently, there is no such structure or score, to facilitate, govern, police, and regulate such transactions or activities. In fact, not having such a platform for such an activity causes situations that embarrass friends/family or produces bad feeling between them, in case of default or bad behavior for transaction or pay-back, e.g., late payments or repetitive/multiple loans from friends or over-stretching one's ability to pay back on time or fully, which is embarrassing to people/family/friends.

To our knowledge, currently, there is not any solution in the market to solve or address these problems. So, people either do not or cannot get into these activities, or they have problems doing it successfully and peacefully, which may end up in unnecessary lawsuits and headaches for family/friends.

### SUMMARY

To have a mechanism to reduce or avoid such problems mentioned above, for family/friends, it would be desirable to set up such a system to govern and police those activities in a orderly and proper manner, with less financial risk or headache. For example, one bad actor or a financially novice person may get a lot of loans from family/friends, intentionally or unintentionally, and nobody knows about that, and he gets overstretched with too many loans, which he cannot repay back, and gets into trouble with many people simultaneously, which is bad for all parties involved, even other family/friends who were not even involved in the transactions or loans/credits, with major headache or long lasting effects in the family/friends circles/members. So, we need a system to avoid or reduce those situations.

With our system, the chance of overstretching and default or bad behavior or repeated behavior reduces drastically, which is good for all parties at the end, especially other family/friends. So, we have designed a system to address all these problems/issues, which increases the e-commerce, commerce, financial reliance, financial activity, and social benefits. It will improve the family/friends relationships. It will aggregate the resources of people to buy something they cannot afford alone. It has an accountability. It is formal. It is based on contract in one embodiment. It has checks and balances. It self-regulates. It polices the community against bad behavior or negligence. It encourages and rewards good and on-time behavior and common-sense/courtesy between people/family/friends.

So, the results are all positive, with no negative side effects. As shown below, it has many components, with many variations for different situations/cases/scenarios. We will give many examples and use cases.

### BRIEF DESCRIPTION OF THE DRAWINGS

FIG. 1 illustrates an embodiment of a system for credit analysis and offering, with multiple social medias, plus our network, SC.

FIG. 2 illustrates an embodiment of a system for credit analysis and offering, with multiple social medias/nets, working with regular banks and credit cards, as well.

FIG. 3 illustrates an embodiment of a system for credit analysis and offering, with multiple social networks, with multiple scoring options: (1) using only SC score; (2) using SC score plus other scores in the industry, e.g., FICO score.

FIG. 4 illustrates an embodiment of a system for credit analysis and offering, with multiple friends, multiple options for action, e.g., co-signing, and other sources of fund, e.g., investors.

FIG. 5 illustrates an embodiment of a system for credit analysis and offering, with multiple components to make and negotiate a contract for loan between user and her friend, with option for consenting for release of info/rating/score/comments by others, plus reporting to social nets.

FIG. 6 illustrates an embodiment of a system for credit analysis and offering, with various actions by friends, e.g., bad reviews, with using (and then updating) the history of loans/financial history of the user/borrower, in our system, SC system/site.

FIG. 7 illustrates an embodiment of a system for credit analysis and offering, with multiple social nets, e.g., Facebook, as sources of scores, to use for status, reputation, credit analysis, credit decision, loan approval, and reporting to social sites/people/members/friends/family.

FIG. 8 illustrates an embodiment of a system for credit analysis and offering, with multiple social nets, to receive reports, as the targets for distribution (lists)/scope and width of the distribution of reports/comments/scores, based on severity/degree of bad/good behavior.

FIG. 9 illustrates an embodiment of a system for credit analysis and offering, with multiple social medias, as sources of scores, to combine as a final score, for reputation and loan approval.

FIG. 10 illustrates an embodiment of a system for credit analysis and offering, with multiple situations, e.g., early payment, commented by a friend, contributing to scores, in various scales, for our system, SC. The system includes appeal sub-system, collateral for loan, verification/authentication/biometrics, and rating the lender, as examples, for loans for cash, its equivalent, and objects/items, e.g., car rentals.

FIG. 11 illustrates an embodiment of a system for credit analysis and offering, with scoring based on various parameters, which then can be used to calculate/assign an interest rate for the loan, by the lender, based on many factors/methods, e.g., using formulas or tables or databases.

### DETAILED DESCRIPTION

There is a problem within our society: One that has persisted for decades now. What do you do if you need to borrow a relatively small amount of money for a relatively short period of time? Would you ask a friend or a relative? Would you risk losing that friendship? Or, would you choose instead to borrow from short-term lenders at ridiculously high rates?

Now let's explore the other side? What would you do if a friend or relative asks to borrow money from you? Would the answer be Yes or No? Yes, plus interest? What's your guarantee that your friendship will stay intact, and you will get your money back? What are the consequences of NOT lending money to a friend?

If you have lent small and big amounts of cash to friends many times in the past, not knowing if there is ever a chance they will pay back, there are many questions in your mind, e.g.: Have they borrowed from others? Are they in the kind of trouble that would make them borrow from multiple sources and bury themselves in debt? Do I even want to be a part of that mess? Is it wise to lend him the money? Does it really help him, or dig a bigger hole for him? What is his financial status? How reliable is he? Did he have a similar situation? And how did he handle that?

So, this is a real problem for both someone in need of short-term help and anyone who is ever asked for a cash loan. Wouldn't it be nice if there was a way to lift all awkwardness and enter a community or better yet a marketplace where friends, acquaintances and perhaps even strangers can lend and borrow with proper agreements, made in advance for everyone's peace of mind? If you are a sincere borrower with the right intentions, you trust yourself with being capable of repaying the debt, as promised. Only if there was a way to induce that same trust in the lender. Now, here comes our system/solution, called StreetCred, or SC.

StreetCred is an environment where one can build credit among his peers similar to how credit is established with financial institutions. It is done through complete transparency of borrower's information, as consented to by himself. Much like a bank that would not loan you money, if you owe more than you can comfortably pay back, or if you have failed to keep your other repayment promises, your friends want to be secure/safe, in knowing your history of how much you owe, how you have treated your peers who have let you borrow money in the past, and the like.

If you loan money to friends based on perhaps sincere promises, only to find out later that they have borrowed from two other friends, based on the same exact premise, which they can never satisfy all those loans simultaneously, and fail under so much debt/pressure. Now, here comes our system/solution:

One purpose of StreetCred is to create a comfortable environment when a truly sincere borrower can provide credible assurances that he is in fact sincere, that he intends to pay back the loan, that there are not other monies being borrowed simultaneously, from other friends, and he can offer to pay back with interest, without making friendship awkward or losing face in his community.

Meanwhile, a good friend, who is willing to help, does not have to feel foolish about helping, does not have to doubt the sincerity of the borrower, and can remain a good standup member of his community, with potentially longer friendship between those.

Here/below, we describe embodiments related to lending and credit evaluations, as well as offering credit/loans/money/cash or equivalent, e.g., bitcoins, for people on social media, e.g., family/friends, to gauge, help, police, regulate, adjust, normalize, set straight, and/or communicate to each other, in terms repayment and credibility/reliability for loan/financial instrument or situation.

Note: The embodiments here are just examples, which can be combined together in any combinations as a new embodiment:

In one embodiment, the loan part can be informal or verbal, or official or on contract, based on template or customized, which our site can provide advice by attorneys or accountants, as well as template to fill up for a simple loan structure, according to laws of each jurisdiction/state/local laws/rules, as an option/embodiment.

In one embodiment, if somebody is on time, the score goes up, as positive parameter/indicator. If somebody is late or at default, the feedback is negative from other people, and the score comes down. If somebody gets too many loans and large sums/amounts, the score come down. If the last loan was very short time ago, the score comes down. If the feedback is good, the score goes up. If the feedback is bad, the score goes down. The bad behavior on social media also brings the score down. If the repayment is fully done, and the balance is zero, the score goes up drastically, as some examples.

In one embodiment, if there is a dispute between the scores/feedbacks/bias/unfairness, between family/friends, our arbitration, selected by our site, which is binding based on the pre-approved agreement with all users, shall decide on all disputes to reduce cheating the system unfairly against an innocent actor. So, one cannot simply bully other people on the site. People can also complain about such people or behavior, with adverse result/consequences against the bad actor, whoever he/she is.

In one embodiment, we describe a “System and Method of Credit Analysis and Credit Offering, based on Social Media”, which can be related to reliability or strength of a person to repay back the loan, or risk analysis or relative risk, or the fund in cash or equivalent, or credit on a credit line or credit card or debit card or attached to the bank account or traditional credit card or home equity or line of credit or 2^{nd} mortgage or 1^{st} mortgage, or any e-coin or bitcoin or electronic fund/money, or generic contract or specialized contract, or a contract which can be sold on a secondary markets or to a financial institution or bank or loan/mortgage company/firm or investors/private equities.

In one embodiment, it can be based on feedback or direct comments or Likes or Dislikes on the social media or on our site, e.g., Facebook or Twitter, or other parameters or surveys directly or indirectly obtained from the family/friends/users, or 1^{st} line of friends or 2^{nd} line of friends, etc., or pushed survey or pulled survey, actively or passively, in a direct or indirect manner.

In one embodiment, it can get some info/data/feeling/feedback from users directly or by interpreting the text, using AI and language interpreters or translators, whatever is available in the industry/off-the-shelf, right now, to extract the meaning and feedback of the user about the friend/family member.

In one embodiment, it can be multiple choice questions or surveys, e.g., for feedback or for graded score, e.g., the score between 300 to 800 or between 0 and 1 or between 0 to 100 or in percentage, or relative or absolute values, or in Normal distribution curve, or any scale, or in linear or non-linear scales, or exponential scale, or the Log scale or Ln/Natural Log scale, or the like. The score/number/value can be edited/updated or changed automatically, manually, or by algorithms, e.g., formulas, or periodically or based on an event/trigger.

In one embodiment, the process can be peer to peer lending/credit processing, as “street credit” or “StreetCred”, based on reputation or other people's opinion/feedback. The sources of money/loan are family/friends, or regular bank or credit card, e.g. by using family/friends' feedback, or the combination of those. It can also be a situation of using regular FICO/traditional score and our score, in combination, to decide about the funding/loan/approval. Or, we can supply our score to FICO or similar organizations to improve their scoring, for reliability and risk analysis. Or, we can incorporate FICO (S_{Fico}) or similar scores into ours, to improve our score/supplement ours, or StreetCred score (S_{SC}).

In one embodiment, it can be based on table, curve, or formula, e.g., averaging or weighted averaging both scores to get a final score, e.g.:

Final Score=S_{F}=(S_{SC}+S_{Fico})/2

Or, to put more emphasis on our score, with more weight:

S_{F}=(2S_{SC}+S_{Fico})/3

Or, even more emphasis on our score, with more weight or relative weight:

S_{F}=(3S_{SC}+S_{Fico})/4

Or, in general:

S_{F}=(N·S_{SC}+M·S_{Fico})/(N+M)

Where M and N are real numbers or integers or coefficients.

Or, in general:

S_{F}=(N·S_{SC}+M·S_{Fico})/G

Where G is a real number or integer or coefficient.

Or, it can be in different power, for more emphasis:

S_{F}=(S_{SC}²+S_{Fico})/2

Or, even higher powers:

S_{F}=(S_{SC}³+S_{Fico})/2

S_{F}=(S_{SC}^{H}+S_{Fico})/2

Where H is a real number or integer or factor/parameter, e.g., H=8.

In one embodiment, the sources of money put all in a bucket as an aggregate or fund for loan to one or more people, as friend/family. Or, the 3^{rd} party can rely on this system and come in and lend to one's friend/family. This can apply to crowdsourcing or funding, as well, from both directions for lending or funding.

In one embodiment, there is a shame factor for delay or bad behavior or default on the loan or over draft on check/withdrawal/from account or line of credit. The personal friends/family know the person well and can score/rate him better. The person who wants to get a loan must give permission for such a report or feedback from others through our site or other social nets, in advance, so that there is no liability/fear/revenge/bad feeling for getting criticism or bad score/feedback, or to have a free/fair or anonymous/hidden feedback/scoring.

In one embodiment, one can see how much his friend has borrowed in the past year from all friends/family/circle. The score/report/history/performance/opinions can also be sold to others or as subscription or as per request. Of course, the person who needs the loan would waive/permit for such a disclosure, beforehand, with no liability for bad score.

Of course, in case of error, the user can appeal or complain to get the score corrected through various channels, e.g., our website or 3^{rd} party private independent judge/arbitration, e.g., with appealing, but with binding result at the end on all parties, who must sign in advance for such a procedure(s)/waiving rights/accepting the binding conclusion or order or judgement.

In one embodiment, for score, if the debt is old, but paid on time, the score goes up. Social reputation, standing, and credibility/reliability become a commodity which is worth some money. For example, if somebody has a good reputation and high score, S_{SC}, then it is easier and lower interest rate for her to get a loan or line of credit on her name. For example, for interest rate, I, we have, as a function, F, of inverse of our score, S_{SC}, or S_{SC}⁻¹ or (1/S_{SC}), because for a more credible person, we have a higher score, as well as a lower interest rate, corresponding to a lower risk (factor/chance/probability):

I=F(1/S_{SC})

For example, we have:

I/I₀=S₀/S_{SC}

Wherein I₀ and S₀ are base or comparison or min or max values, for interest rate or score, respectively. For example, we have:

I/Iₘᵢₙ=Sₘᵢₙ/S_{SC}

Wherein Iₘᵢₙ and Sₘᵢₙ are min or minimum values, for interest rate or score, respectively.

### Or:

I=Iₘᵢₙ·Sₘᵢₙ/S_{SC}

Similarly, e.g., we can have, in another example:

I=Iₘₐₓ·Sₘₐₓ/S_{SC}

Wherein Iₘₐₓ and Sₘₐₓ are max or maximum values, for interest rate or score, respectively.

The relationship can be non-linear, as well, e.g., in a power of integer or real number, Q, e.g., 2, or square:

I=Iₘₐₓ·Sₘₐₓ^{Q}/S_{SC}^{Q}

I=Iₘₐₓ·Sₘₐₓ²/S_{SC}²

Or, e.g., in a reverse fashion, squared:

I²=Iₘₐₓ²·Sₘₐₓ/S_{SC}

Or:

I=SQRT(Iₘₐₓ²·Sₘₐₓ/S_{SC})

Wherein SQRT is the square root function or operation.

In one embodiment, the interest rate can also be based on more complex formula, e.g., Exp or Log or Ln functions (exponential or logarithmic in different bases, e.g., base 10 or e, or natural log), or combination or derivatives of those, or table or curve or based on experience or history, based on risk analysis or past performance of one person or persons or aggregates of many people over a period of time, or averages or weighted averages of such values. Or, it does not have to be any reason for it, or be based on numbers charged by banks or credit cards at the time, or be based on prime rate or based on WSJ or Feds or Federal Reserve System rates or numbers, as a equal value or as a function of those values, or combination of those values, e.g., as a formula or relation between them.

In one embodiment, if somebody does not pay on-time, then he has already consented to send a note/notice or notify the friends/family/connections, through our website or through social websites/channels/forums, e.g., Facebook, Twitter, Instagram, or the like, which is automatically generated and sent, regarding late payment/default/bad behavior of any sort, with description online or by email, text, message, voice message, phone, fax, mail, other types of messaging, displays, forum, media, post, notice, poster, listing, announcement, message board, or the like, with a push or pull model, or broadcasting or the like.

In one embodiment, the circle of announcements and notices have different tiers, e.g., nearest friends, regular friends, and the like. The severity and seriousness of the bad behaviors have also different classes, e.g., complete default, which are mapped to different tiers of circle of friends, for notices, based on pre-announced rules, so that the bad actor knows beforehand that who gets what notice in what situation, whose rule is known to all parties involved for certainty and peace of mind for all parties, in advance. That is, how wide a distribution in what type of bad behavior, for how long, and how to stop it, or correct/reverse the bad behavior, or even appeal/reverse the decision, in case of error in judgment.

The spread/width of distribution can be negotiated at the beginning, or as a counter-offer. The person cannot unfriend anybody during this process, to avoid embarrassment/notices to people. That is, he cannot hide from consequences and notices to family/friends. The different tiers and classes mentioned above are in the menu, with color-coded, check-marked, with various limits/thresholds, e.g., for number of days for delay or notices and which social networks to use and by what method of delivery of notices of bad behavior.

In one embodiment, for the good behavior, the good notice goes out and the score goes up, with the same methods mentioned here for the bad behaviors. The degree of default can be classified, e.g., 30-day, immediate, medium, long-term, or the like. For a new account/user, the distribution is usually wider, because he does not have any history, indicating more risk.

Upon the loan approval, all parties involved can understand the status immediately, for any future loan approvals, with various details for various type of people, which can be chosen or set beforehand, or negotiated in advance. The loan approval can be manual, automatic, by formula, by threshold, by scores, by no fixed rule, by rules, by decision surface, linear programming, or the like.

In one embodiment, the 2^{nd} layer friends also can understand the loan status, in one example for filtering for width of distribution, or it can be dynamic, changing regularly, periodically, or based on a trigger or event or condition, governed by a rule and through a rule engine, using a processor/microprocessor/computer/server/server farm/computing device.

So, people rate others, as raters, and the raters also get rated back, by others, for fairness, in case there is a bias or bad actor among the raters, to adjust and correct the behavior of the raters, as well. So, it is a 2-way street/feedback in both ways.

Social/credit status/standing/worthiness, fairness, credibility, and reliability become a commodity/prestige/source of proudness, in community for both borrower and rater in social net or our website, based on which the money or loans can get initiated or credits extended or approved, in a fair and accurate way, in which FICO or banks have generally no access to such a detail from outside, making them less accurate/less fair, compared to our score/system/approval process.

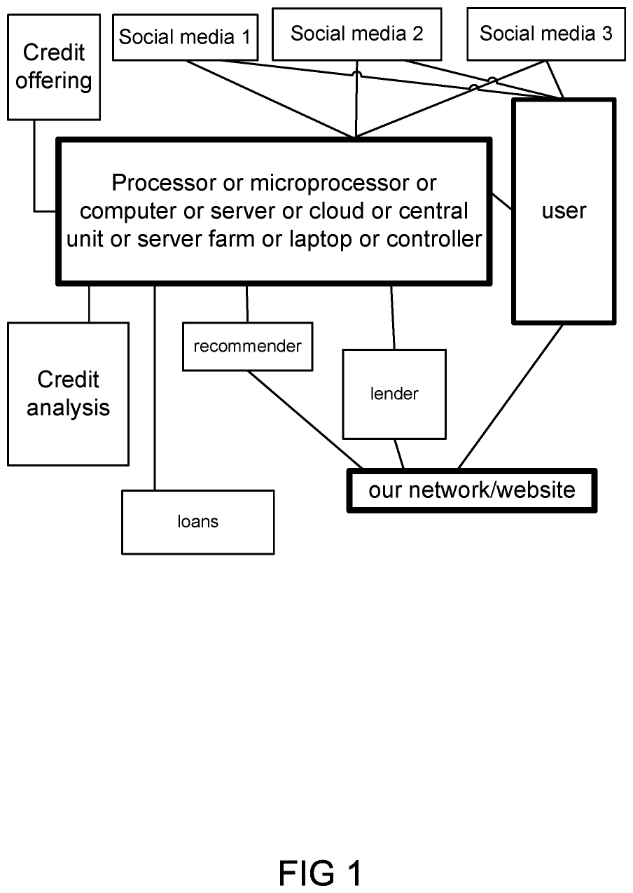

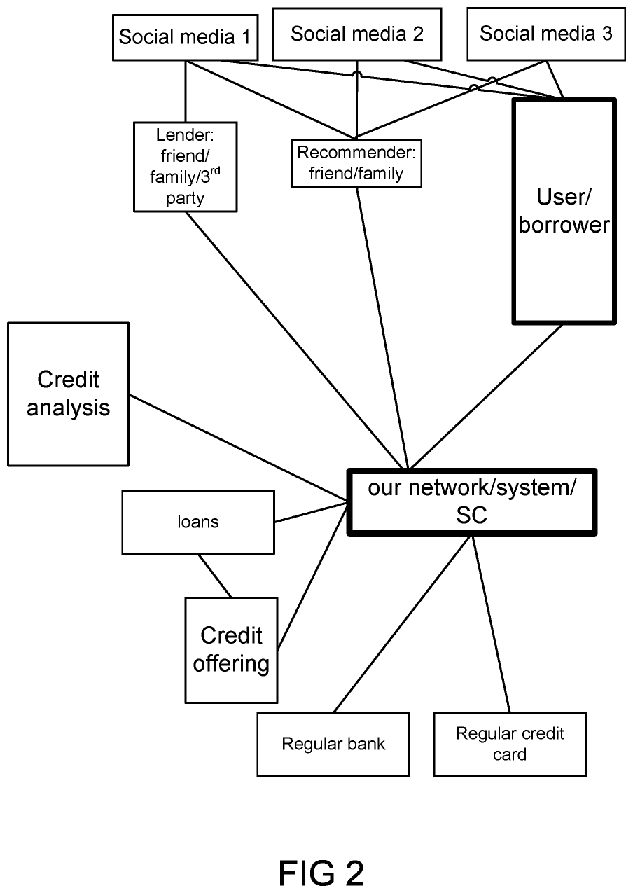

Here are some other embodiments/examples for our/SC system/method: FIG. 1 illustrates an embodiment of a system for credit analysis and offering, with multiple social medias, plus our network, SC. FIG. 2 illustrates an embodiment of a system for credit analysis and offering, with multiple social medias/nets, working with regular banks and credit cards, as well.

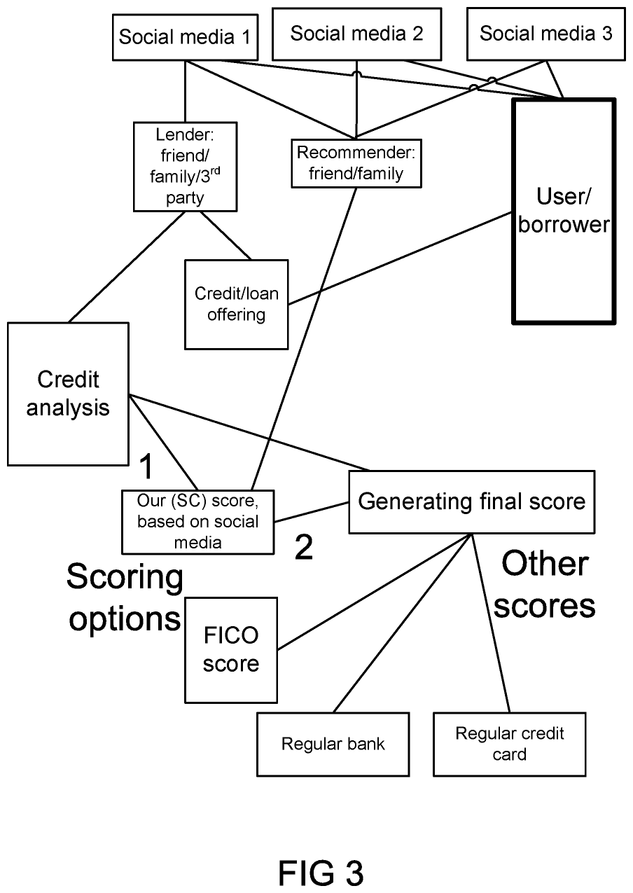

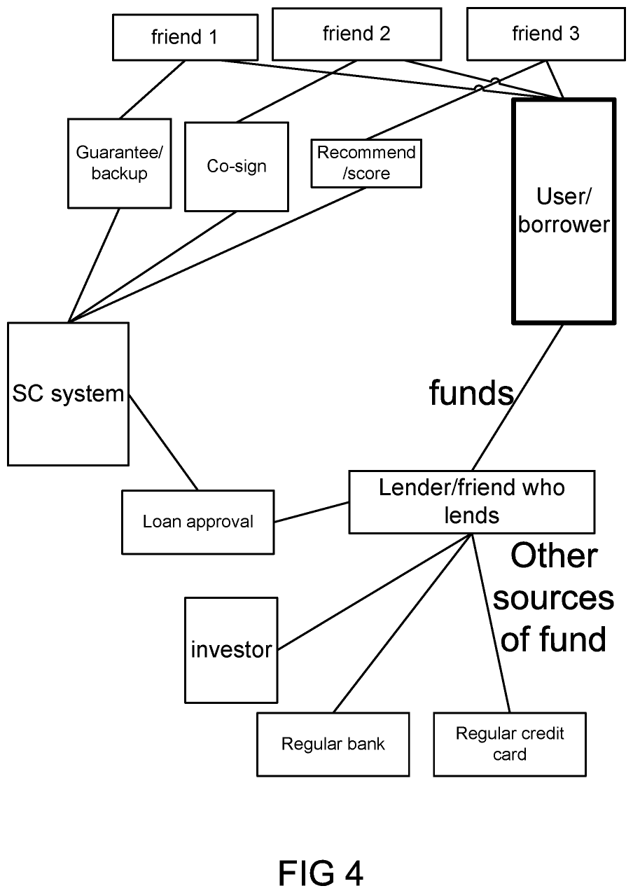

FIG. 3 illustrates an embodiment of a system for credit analysis and offering, with multiple social networks, with multiple scoring options: (1) using only SC score; (2) using SC score plus other scores in the industry, e.g., FICO score. FIG. 4 illustrates an embodiment of a system for credit analysis and offering, with multiple friends, multiple options for action, e.g., co-signing, and other sources of fund, e.g., investors.

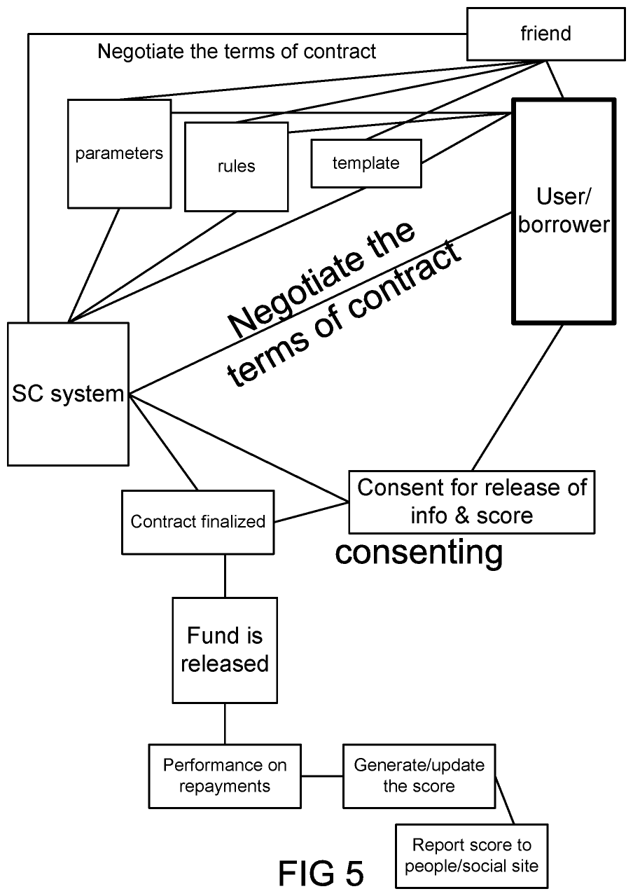

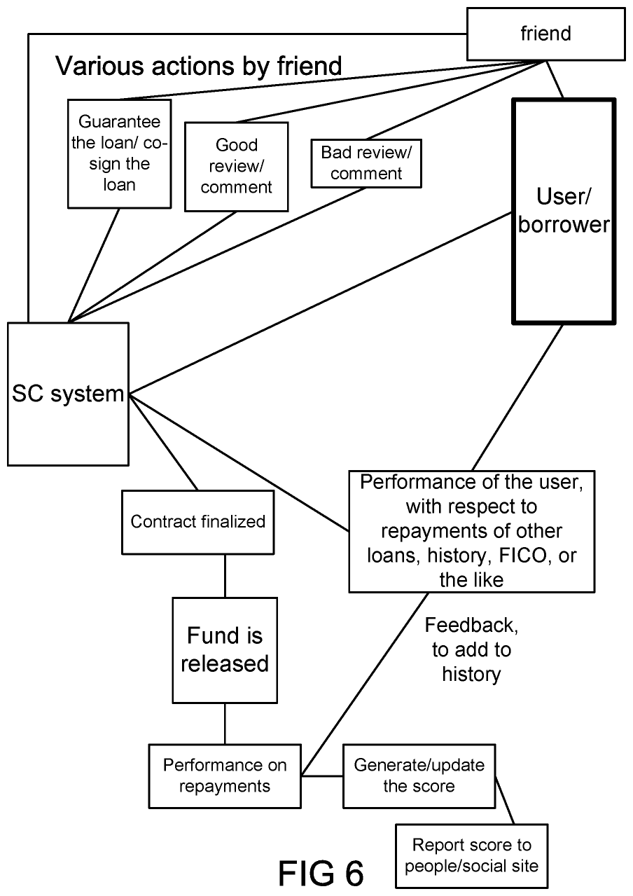

FIG. 5 illustrates an embodiment of a system for credit analysis and offering, with multiple components to make and negotiate a contract for loan between user and her friend, with option for consenting for release of info/rating/score/comments by others, plus reporting to social nets. FIG. 6 illustrates an embodiment of a system for credit analysis and offering, with various actions by friends, e.g., bad reviews, with using (and then updating) the history of loans/financial history of the user/borrower, in our system, SC system/site.

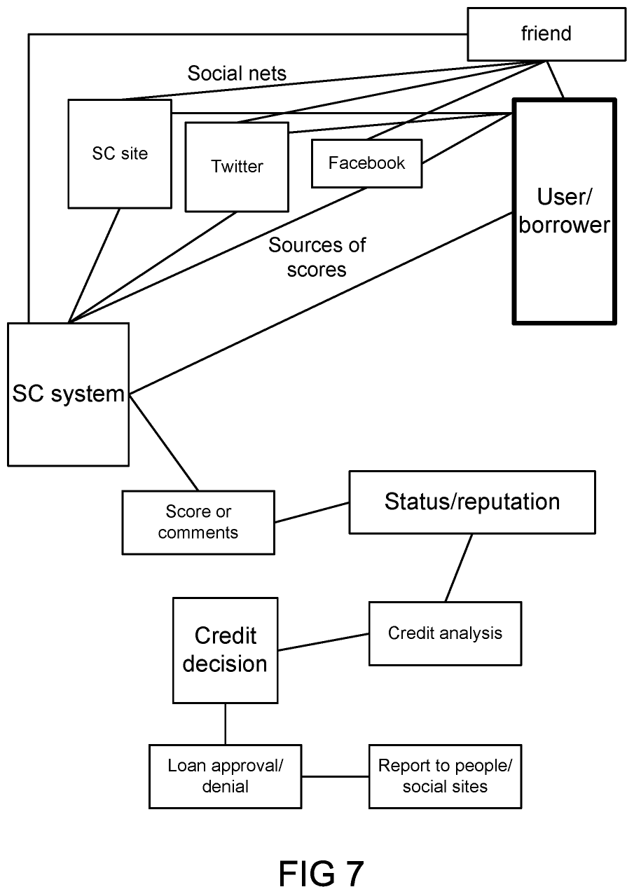

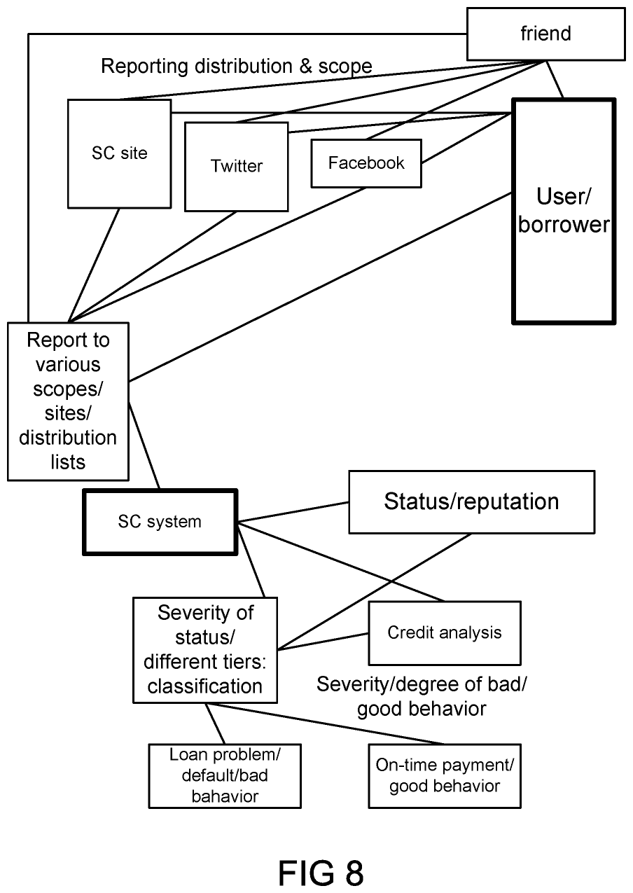

FIG. 7 illustrates an embodiment of a system for credit analysis and offering, with multiple social nets, e.g., Facebook, as sources of scores, to use for status, reputation, credit analysis, credit decision, loan approval, and reporting to social sites/people/members/friends/family. FIG. 8 illustrates an embodiment of a system for credit analysis and offering, with multiple social nets, to receive reports, as the targets for distribution (lists)/scope and width of the distribution of reports/comments/scores, based on severity/degree of bad/good behavior.

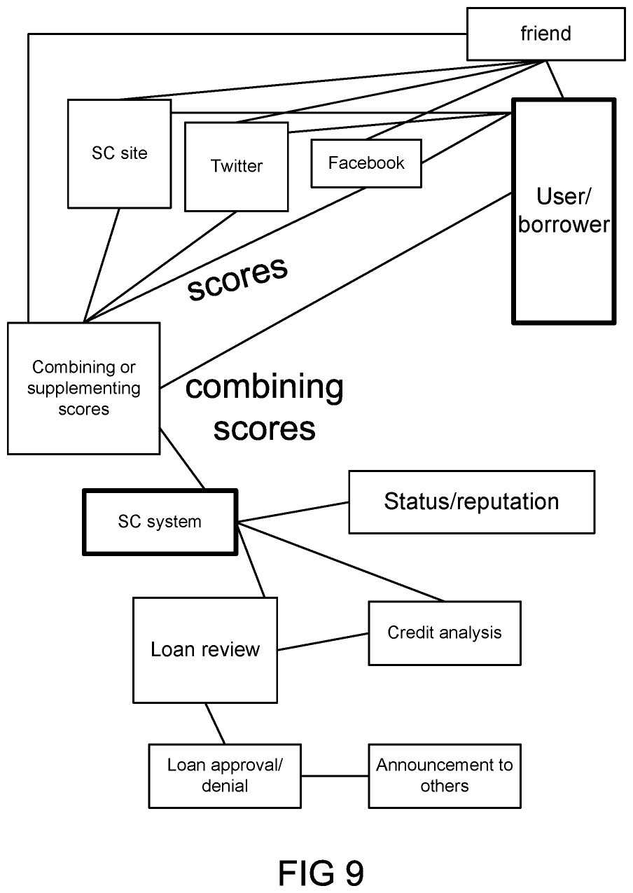

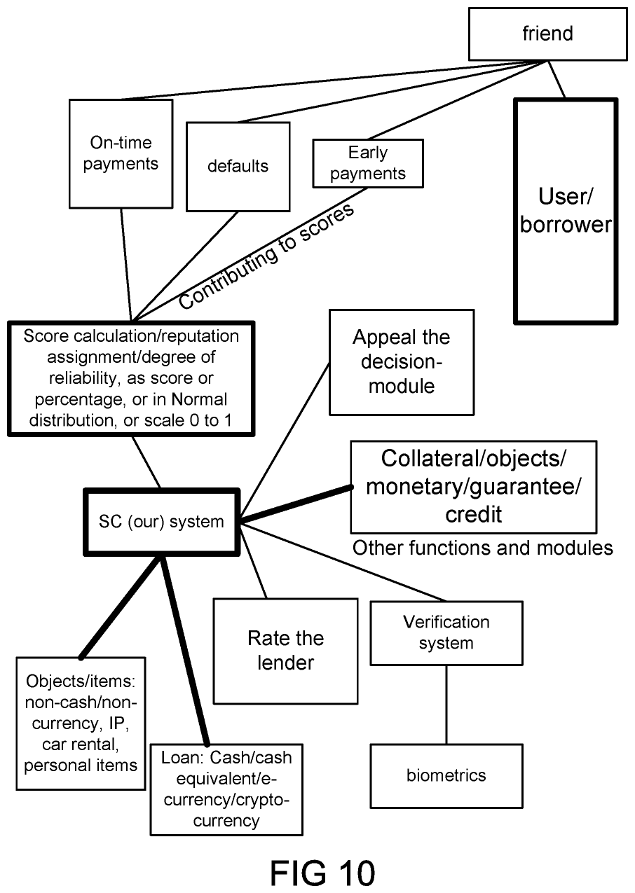

FIG. 9 illustrates an embodiment of a system for credit analysis and offering, with multiple social medias, as sources of scores, to combine as a final score, for reputation and loan approval. FIG. 10 illustrates an embodiment of a system for credit analysis and offering, with multiple situations, e.g., early payment, commented by a friend, contributing to scores, in various scales, for our system, SC. The system includes appeal sub-system, collateral for loan, verification/authentication/biometrics, and rating the lender, as examples, for loans for cash, its equivalent, and objects/items, e.g., car rentals.

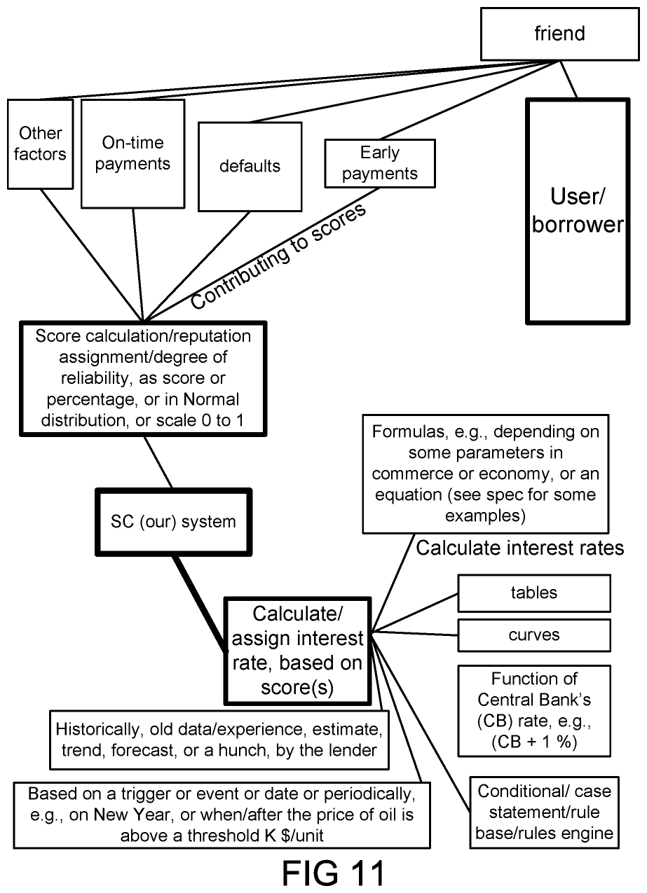

FIG. 11 illustrates an embodiment of a system for credit analysis and offering, with scoring based on various parameters, which then can be used to calculate/assign an interest rate for the loan, by the lender, based on many factors/methods, e.g., using formulas or tables or databases.

In one embodiment, the collateral or objects borrowed or given can be added to the mix. The banks and credit cards can have an agreement with us, so that collateral can be attached to their banks and credit cards, through their accounts or credit lines, or gets locked or becomes unavailable for that portion/value. Or, they can be used, in case of defaults or lack of payments. These all can be part of contract at original template for agreement/review/negotiations, or changing parameters/counter-offers, to be known to all at the start, for formal agreement.

In one embodiment, the collateral or lock can be on regular pay-checks or account receivables or salaries or tax returns, or any combination of them, or any tangible or intangible items or IPs. The agreement can be signed by hand or electronically on paper/screen, e.g., by PKI private signature or e-signature or passwords or real signature or the like, on forms by companies such as DocuSign or other services.

The penalty or extra interest for delays per day or grace periods can also be added to the contract. The cash or e-payment or credit cards or debit cards or banks or bank accounts or Zelle type payments or Venmo/digital wallet/sharing payments or Paypal type payments or smartphone payments or Alipay type or Apple-Pay type, or the like, can be attached/related directly/indirectly to the loan or contract or person's account or social net, for direct or automatic withdrawals or backup or confidence or payments or credits or the like.

So, we can partner with the list above, e.g., a cash app, or our own cash app, for mobile payments and transactions, or verification or authentication or biometrics or ID, via a phone or smart phone/mobile device or IoT or wearable device, or for recordation of payments and transactions. The delivery of info/fund/credit/results is by any means mentioned in this spec, including mail, email, texting, hand-delivery, broadcasting, twitter, or post in our site or on social net board or billboard or wall or post.

In one embodiment, the various levels of payment and membership/subscription or free-level exist, e.g., professional, casual, monthly, pro, investor, family-only, inner-circle, or the like, with different privileges and capabilities/permissions, with tiers/levels of payments/fees for each. The fee goes to our site and other entities, based on a fixed, percentage, or min fee, pre-disclosed to all.

In one embodiment, it can be used for investment for friends/family, or as a gift, or co-investing, e.g., between kids and parents, e.g., for profit or for non-profit. Our system reduces risk and eliminates/reduces risky or bad behaviors. It can issue stocks and certificates. It can make somebody super-safe, when one has a large credit or backup cash. It can be for wedding or graduation gift or toward college funds, or with collaterals such as payday loans or car titles/house/other valuables/IPs.

In one embodiment, our site/system, called SC, uses the technology in ID readers, ID recognition software, scanners, and the like, including facial recognition and thumbprint readers, to identify all or some people that join either as lender or borrower, or both, or other parties/actors.

In the age of social media, transparency of such information among peers should be quite easily achieved. You can sign up for StreetCred and begin to build you credit almost immediately. In one embodiment, in order to sign up, you need to:
1—Verify your ID by various means. For example:
   a—Facial recognition.
   b—Thumb/finger print/other biometrics.
   c—Driver license or other government issued IDs. or
   d—Third party ID verification companies.
2—Register multiple social media profiles, belonging to you under the same name.
3—Multiple personal references with verified IDs.
4—Announce your participation in StreetCred on your multiple social media accounts. This way, there is more assurance for the lender that there are not any outstanding debts to other friends.

Other Items, such as posting a complete and current job history, will be a prudent part of the actual borrowing process, and a good borrower will have all such assurances lined up ahead of time, e.g., through our site, resume, or Linkedin, possibly verified by a 3^{rd} party or services. Also, sequential snapshots of paystubs or direct-deposit paychecks are a good idea.

Members can register as borrowers, lenders, or both. It is recommended, or maybe required in some examples, that members publicize their membership, so to create awareness and thus, to help create a bigger community for potential future transactions for themselves and others alike.

A very basic scenario: “A” needs $500 on Monday to make his car payment of $300, and a $100 power bill, so to avoid a credit ding, and have $100 pocket money. He gets paid on Friday. Normally “A” has very limited options, and usually he will end up at a payday loan office, or a title loan office, and will have to pay astronomical interest rates.

Now, with StreetCred, “A” can approach “B” with confidence. He can either choose from peers who are already members of StreetCred, or he can invite “B” to become a member and review “A”'s profile and decide whether he can lend him the $500 and come up with an agreement in order to get repaid. StreetCred will offer basic agreement templates or some interchangeable components with which an agreement would be formed. These components can be set to kick in automatically, as various thresholds are reached. These components may include some of the following, in one example:
1—Certain portion (amount or percentage) of “A”'s paycheck, every payday, are direct deposited into “B”'s account.
2—The title to “A”'s car is signed over to “B”, and if “A” stops receiving a regular paycheck, “B” is alerted to take action.
3—Upon any late payment “A”'s credit history on StreetCred is noted.
4—Upon an agreed-upon number of days of late payment or number of late payments, some of “A”'s social media contacts will be sent a newsflash. (Remember that this is all “A”'s idea, so he can borrow money and build Peer-Credit. It is not meant as a hostile setting against “A”.)
5—“A” can offer his smartphone contact list.
6—“A”'s smartphone contact list and his social media friends or contacts can remain hidden from “B”, even though the alerts may still go out to all or some of them, in case of non-payment.
And the like.

One's reputation and social standing is a commodity that is difficult to replenish. It can be leveraged as a quasi-collateral in order to secure repayment of a loan. This reputation can be among a few, many, or everyone you know. It is up to the borrower to offer how widespread a collateral he is willing to put up, and up to the lender to accept the offer or ask for more. It is negotiable on the template for our website at SC.

So, for example, the borrower offers a few reputable friends or peers as references, and in case of an agreed upon degree of default on loan repayment, the same peers will be notified, thus, the borrower losing face with them. Or, he can offer all his friends on FaceBook or Twitter or Linkedin or other social media or his contacts on his smartphone or all of the above or a few of the above, as a subset. These contacts can be notified in a variety of ways. These notifications can come at a variety of thresholds in repayment defaults: They can vary in harshness or severity, and they can be delivered in a variety of ways, which the users can set, or negotiate, e.g., by texts, instant messages, private posts, public posts, emails, and the like.

StreetCred (SC) can have a rating system for your peers to rate your borrow-worthiness and lend-worthiness, with money or other things, such as a car or book or dress or baseball bat. For example, I give John 5 Stars, because he borrowed my car last week for a day and retuned it washed and with a full tank of gas. Or, I give Joe 3 stars because, even though I appreciate the fact that he let me borrow his car, he made it very difficult for me. These comments can only be made by verified profiles. They can be hidden or visible to some or all, based on the conditions/rules.

SC will keep track of your payments and all transactions and can provide all details for tax purposes or per quarter/annually. You can verify social media contact list and download onto SC. Maybe, lender will not be able to see the list, but only knows the number of profiles. Maybe, lender can see actual profile with borrower's permission. Remember that in general case, the lender and borrower do not necessarily know one another, e.g., as a 3^{rd} party or 2^{nd} level friend. Maybe, there can be a setting to disallow borrower to turn off social media before debt is fully repaid, with full consent beforehand.

Maybe, there is a setting to let every contact/friend know there has been a SC transaction, but not tell what kind of transaction it is. Whether it is intent to borrow, lend, or any other type of dealings, these settings can be chosen beforehand. Maybe, closed or new social media accounts will not allow borrower to open or reopen account, unless debt is fully repaid or now disclosed to all new friends automatically.

Ultimately, SC should have a Credit Check app within it or as a third party, in order for lender to be able to check borrower's credit. All transactions on SC is electronic, and verified and kept track of. At some point, banks will have access to quite a lot of data on SC, aiding them in determination of creditworthiness of a loan applicant for themselves later on.

Traditional collateral, tangible, digital, future paycheck, car title, or the like can also be added. Popular and widely accepted document signing apps can be integrated here. SC will either be a “Cash app” similar to Zelle or Venmo, or will use a cash app in partnership. All loans and repayments will either be made directly on the app, or be made verifiable and documented on the app, as one example.

There will be various types or levels of membership based on various factors, for example, “pay-per-transaction” or monthly or casual or pro. SC may have a series of “items of agreement” for repayment. The two parties can choose as many or as few of the items as they wish, in order to customize their repayment contract.

One of the unique “items of agreement” can be that if a payment is missed, either as agreed up front, or because of borrower's fault, a bonus amount can be added to the last payment, or all remaining payments are bumped by an amount or a percentage. And/or, there may be an early payment bonus for the borrower.

So, for example, a borrower whose payments begin in March knows in advance that there is a reason that he will not be able to make his payment in July and August. Thus, the agreement will be that the payment schedule moves two months down the calendar, but at the end, he will owe an extra $50 for each of those months. Or, the upfront agreement will be that if he misses a payment without upfront notice, each payment thereafter will go up by e.g. 2%, or an extra payment will be added to the end of schedule that equals 2% of all payment added. So, e.g., if the scheduled payments are (X+set interest), then the agreement can be that if a payment is made 2 weeks early, then the amount shall be (X+half of set interest).

SC employs existing credit and banking practices, with features such as customizable terms between lender and borrower. Co-signed loans have added terms. For example, after a set number of missed payments or various defaults, the loan may become entirely the responsibility of the co-signer(s), all the while damaging the credit of only the original borrower. After that, the cosigner(s) will now become the primary borrower, with the risk of damaging their own credit, if not pay on time, as an example. All of the above can be customized in the beginning by choosing various “agreement items” made available/known to all parties.

StreetCred is essentially about proper reallocation of funds, in one example:
X & Y are peers.
X needs money, and Y has money.
X borrows from a bank or a payday loan or a title loan operation and pays very high annual interests.
Y keeps his money in the bank and receives very little interest.
Today, without an apparatus such as StreetCred, Y cannot safely and securely lend money to X, without risking both his money AND his friendship.
StreetCred will allow Y's money make Y more money and save X money, at the same time.

In this example, we refer to borrower as B and lender as L: For Payment assistance for existing loans:
Perhaps, e.g., B loses his job or is furloughed for a period of time. This means he cannot make his mortgage payments for undetermined number of months.
B & L can form an agreement, by choosing from SC “agreement items” or by creating their own, for L to make B's mortgage payments until B starts to get paid again and is able to do so himself.
So, the amount of money borrowed by B is variable and is based on the length of furloughed time.
The repayment agreement can be made by various terms:
   a) Once B starts to get paid again, a traditional type payment with interest will commence on weekly, monthly, bimonthly, and etc.
   b) A lower periodic payment is set (without reducing balance) until B is fully back on his feet and can either make normal payments or a balloon payment occurs.
Traditional collaterals, such as deed to property, maybe signed over, in addition to social contacts.

This turns the social net into an entire lending and borrowing society. Example, in another setting, for this scenario below, for borrowing a car, on my reputation:

I have a great reputation among my friends and family. I am clean and reliable. If I ever need to borrow anything from anyone they always say Yes. I always return everything, even in better condition than it is in when I borrow it. I actually have built that kind of reputation for myself and my wife on Airbnb among the people whose places I have stayed in. I have a cousin, Sam, who is exact the same way. I have a friend April who is the exact same way. Problem today is that I cannot carry that reputation with me. If I am in Seattle for only a few days, I have no reputation there. (Well, except for instance, my status on Airbnb, as a Super-guest) So, now, if I am in Seattle for a week, and I do not generally need a car throughout my stay, but I do need a car for one single evening, because I have a business acquaintance, whom I need to pick up from the airport, and I need to impress. What am I to do? I need a high-end car! Well, how about if there was an app that let me carry my reputation with me! The fact that I drive a Maserati at home and that I keep in a great condition will certainly go a long way, especially if I wanted to borrow a high-end car from someone in Seattle for only an evening, for a premium, of course.

So, SC system can carry me for another object, such as a car, in another city, with strangers, with much discount/savings, compared to a regular car rental company, such as Avis or National. April and Sam can also vouch for me, as well, to increase me score/credibility, in this situation, especially if one of them has a contact who has a high-end car in Seattle.

So, this can apply very broadly to many objects, settings, people, and entities. For example, let's say a family of 5 including a 3 year old want to travel across the country, from LA to DC, to visit family for a few days and then to NYC for a week and then back home. A baby stroller is among the toughest items to pack and keep clean in transit. How about if the mom could find someone with a good reputation near their destination who has a stroller she could borrow for a few days? This is good for all parties.

The list of what you would need to borrow or the scenarios, whether you are home or traveling, is almost unlimited, so is the number of people with garages full of bicycles, heavy coats, tools, oversized coolers, tents, skis, and all kinds of useful items, that they would love to either sell or lend out, and cash-in. So, everybody wins here. All you need is a marketplace of sorts where the lender and the borrower can establish a trust base and a reputation, as we have in SC.

For car and truck borrowing, you need stricter rules and conditions. For example, the borrower could either transfer his own insurance for the period of time, or buy daily insurance, as one would, when renting a car from an agency. This will disrupt the car rental industry. The local rules and regulations have to be observed, as well.

Other details are for verification of condition of borrowed item at the time of pickup vs drop-off, or ease of access to item at time of pickup, or whether lender demands that borrower carries AAA membership, or the like.

For the “items of agreement” that the parties can choose from, in order to create a customized repayment contract, it can be a standard template that would cover enough to be used on its own as an entire repayment contract, with some optional items to make it more customizable online.

In one embodiment, we have a method of credit analysis and credit offering, based on social media, said method comprising: a first processor receiving name of a first person from a first social website; said first processor receiving a first score for said first person related to said first social website, from said first social website; wherein said first score for said first person related to said first social website is related to risk factor, reputation, reliability, credibility, and creditworthiness of said first person; wherein said first score for said first person is obtained from a subset of members of said first social website who are directly connected to or befriended with said first person, based on said risk factor, reputation, reliability, credibility, and creditworthiness of said first person, produced through a second processor at said first social website.

The first person registering with a second website for financial transactions, commerce, or e-commerce; said first person accepting conditions and rules set by said second website on said second website; said first person sending a request for a line of credit or loan through said second website; wherein said line of credit or loan is based on one or more of following: cash, electronic money, e-currency, cryptocurrency, a tangible item or commodity, an intangible item or commodity, foreign currency, valuable material, precious or semi-precious material, stone, or metal, intellectual property, stock, an entity's credit, or a currency equivalent; a second person or entity evaluating said request by said first person, regarding said line of credit or loan through said second website, based on said first score for said first person; said second person or entity responding to said request by said first person, regarding said line of credit or loan through said second website; said second person or entity negotiating terms and conditions of said line of credit or loan with said first person, through said second website; both said first person and said second person or entity accepting said negotiated terms and conditions of said line of credit or loan, through said second website; said first person receiving said line of credit or loan, from said second person or entity; said second processor calculating and updating said first score for said first person, based on performance of said first person on said received line of credit or loan, with respect to said negotiated terms and conditions of said line of credit or loan. The second processor reporting said updated first score for said first person and said performance of said first person on said received line of credit or loan, to said first social website or to some or selected members of said first social website.

Other options/variations are:
getting FICO score or another equivalent score from a bank or credit card company.
combining or supplementing FICO score or another equivalent score from a bank or credit card company with said first score.
combining or supplementing a second score from a third social website with said first score.
combining or supplementing a second score from a third social website and a third score from a fourth social website with said first score.
reporting bad behavior, late payment, no payment, or default.
reporting good behavior, on-time payment, early payment, or loan complete payoff.
said first person consenting or agreeing to reporting good behavior and action or bad behavior or action to family and friends associated to said first social website.
said first person consenting or agreeing to reporting good behavior and action or bad behavior or action to family and friends associated to said first social website and a third social website.
said first person consenting or agreeing to not cancel or terminate said first person's account on said first social website.
said first person consenting or agreeing to not block any friend or family on said first social website.
said first person consenting or agreeing to not unfriend or terminate any friend or family on said first social website.
classifying bad or good behavior in multiple tiers, based on severity or seriousness of said bad or good behavior.
announcing or reporting bad or good behavior in multiple distribution lists, based on severity or seriousness of said bad or good behavior or said bad or good behavior's tier or classification.
announcing or reporting bad or good behavior to different people, friends, or family members, based on severity or seriousness of said bad or good behavior or said bad or good behavior's tier or classification.
announcing or reporting bad or good behavior to different people, friends, or family members associated with different social websites, based on severity or seriousness of said bad or good behavior or said bad or good behavior's tier or classification.
announcing or reporting bad or good behavior to different people, friends, or family members, at various times and time periods and at various scopes, based on severity or seriousness of said bad or good behavior or said bad or good behavior's tier or classification.
appealing a decision regarding bad or good behavior to an arbitrator.
rating a lender.
vouching for a friend on said first social website.
confirming identity of a friend on said first social website.
co-signing a loan for or with a friend on said first social website.
guaranteeing or backing up a loan for a friend on said first social website.
connecting or introducing a friend to another friend on said first social website.
rating, scoring, classifying, or commenting on a friend on said first social website.
recommending a friend on said first social website to an entity or another friend.

So, the general idea is to have a reputation-based lending and borrowing platform for money, and many more items in the future, including cars, furniture, and useful stuff that is sitting in storage/garage/attic most of the year. Other alternatives to the “StreetCred” name may be “Reputation”, “Rep”, or “StreetRep”. So, you can carry your reputation, and that enables many things happen, which otherwise, would not be possible, as described here.

The final say on approval of a loan belongs to the lender, however, SC can offer a rating tool based on certain information, such as:
collateral offered:
   a) tangible.
   b) number of contacts.
   c) source of contacts, i.e., social media or smart phone or LinkedIn.
available history of borrower.
number and quality of testimonies on behalf of borrower.
co-signers.
verified identity of borrower.
and the like.

This rating tool can be tracked in the future. It can help in future lenders decisions and ultimately serve as another universal credit rating tool for the borrower for banking and conventional loans, for regular banks. This rating tool will be on one or more scales, such as A-Z or 0-1000 or a color scale, e.g., Red-Green.

Some of these ratings provide a window to borrower's history, while some help Lender make a decision on today's creditworthiness of borrower. For example, there is a number rating associated with a borrower that will not change today. However, if he provides more collateral or more friends to vouch or more co-signers, the color scale will move more toward Green/favorable score/rating.

The lender is also rated. He is rated in more than one way. A few examples:
1—rated by borrower based on how strict he is. This will help future borrowers to evaluate whether to even approach this lender or not based on their own preparedness.
2—rated by SC based on how many collaterals they ask for, how many of SC's “agreement items” they use, how many late payments or non-payments they have encountered throughout life of loans, or how flexible or forgiving they are.

SC will also serve as an environment where a lender can offer his services to other lenders for a fee, or as a platform for other lenders, or as a rental virtual office for them. The above rating system will largely help other lenders to decide whether they would like a secondary lender to manage their funds.

It would help secondary markets, as well, where they buy the mortgages or loans as a whole or batch or wholesale. It can also assign a number or rating with the quality of these loans, based on score of people and past history, for risk factor or reliability, for chance of repayment or default, for all, in average, as a whole package.

In one embodiment, we have a credit line from the lender friend, e.g., 10 k$, which may come from multiple lenders/sources/friends, which can be borrowed partially in the month, e.g., 2 k$, and repaid at the end of month, opening 10 K$ credit line again, which in effect can compete with credit cards and banks, or bypass them, using lower rates and no middle man or overhead, with small or big loans, very conveniently/fast, to replace those vehicles.

In one embodiment, we have a more lender-centric practice, for credit line or cards, where the fund is at SC site, ready for borrower, under the limits set before. In one embodiment, we have people aggregate/pool together as people or entity, as a group, as a lender or as a borrower. They can also lend to others in a hierarchy, if permitted under contract.

In one embodiment, we have profiles for lender and borrower, as a resume/ad/PR, with other info by other people, supplemented as comments and feedbacks, e.g., good, fair, tough, on-time, trust-worthy, high success rate, easy going, reliable, friendly, or the like, for people in each side.

In one embodiment, we have peer to peer credit card, a line of credit, or a revolving line of credit, or open line of credit with a set maximum limit, extended by one peer or group of peers, to another peer, to use as needs arise, or for a specific purpose, or for a period of time, or the limit increases, as time passes, for good credit people with on time payments/history, in a period of time, for increasing score, as an example.

The way the borrower accesses the funds is either on his smartphone, the same way as their Apple Pay or similar, or have an actual physical card, similar to a credit card, or the like. In one embodiment, SC has a bank. In one embodiment, SC is not a bank: SC works as a go between for peer to peer lending, in putting social media to another important practical use.

Lenders have profiles. One area of each profile is populated by information directly inputted by the lender himself (or a representative), and it speaks about their personalities and why they lend, etc. A second area of profile has info entered by SC or friends, based on lender's history, success rate, complaints logged, quality of work, etc.

This second set of information provide aid in rating the lender and move him up or down the page. This is where borrowers can shop for lenders and choose them based on the provided information/scores/ranking/comments.

Lenders get discounts, prizes. Hearts, Stars, recognition, etc., based on success, number of loans, total cash in work, etc. A stellar rating or prize or discount for lender can be transferred to another lender. SC may offer a setting where a “finder” will introduce a lender and a borrower to each other as a service for a “finder's fee”.

A scenario: In one embodiment, we have peer to peer credit card, for virtual or digital or real money. As an investor, volatility in markets is a stress not worth having. As a landlord, you have to jump through many hoops and pay high mortgage rates, hoping to make an extra dollar, over what your mortgage payments are. That is if housing stays strong. Instead, you can put, for example, $10 k in your SC account, and have 10 people each holding a $1 k credit card/line/debit card, and pay you 6%. Also, your eggs are not in one basket, reducing the risk.

A scenario: An 18-year old, Tom, has a job at the local carwash. He is a good kid. He has no credit. He applies for a SC credit card with his mom as a co-signer. His mom decides the initial credit limit. A lender who has $10 k in a SC account decides to extend Tom and his mom a credit line in form of a credit card. Tom gets to establish credit, so he can buy a car soon. Mom gets an app that notifies her with every transaction. She, as the co-signer, is directly next in line of responsibility. If Tom defaults, mom gets to stop the credit line, and takes on the payments. As Tom establishes a good name and credit, he may have an independent card, increase his limit, lower his interest rates, and become independent, financially.

A scenario: Bob is an adult, has a job and has no credit or bad credit. With SC, he can use his social reputation and his car title, as collateral, and get a credit card, or add a co-signer, similar to the example above.

Lenders can be either individuals and work one-on-one with credit line/card holders, know each other, and be a part of a small community, or they can be anonymous investors who get to choose the credit card borrowers through social media and all the collaterals they offer, in order to extend a credit line to them, or a hybrid between these 2 extremes.

From the get-go, a member can ask family and friends to rate him in this regard, in advance of any loans being discussed. This could be all or a select few friends, who make such ratings or provide references. Their identities are verified, and their comments can be altered or removed by them or by either party. This is to serve as building blocks of a reputation based on which future transactions can be decided, as an example.

A person cannot see who said what in rating them, as an example. Only they can see a final rating. Or, in another example, they can see the details of ratings/sources. In one example, each borrower will have multiple ratings on display or available:
1—their social trustworthiness based on what their friends generally think of them.
2—their FICO or other traditional credit scores.
3—their SC credit score, based on the past SC transactions.
4—their loan-worthiness on a given day based on current facts and collateral offerings/co-signs/credit guarantees/backups/credit lines by a 3^{rd} party.

To avoid bad-ratings, as-a-joke, or as a revenge, etc., the identity of a rater or reference can be verified by various methods, e.g., by biometrics, however, it may be hidden from the person being rated and others.

As a remedy to an untruthful negative rating, such rating can be challenged by the rated, if there are far less negatives than positives, or it does not match/correspond to other ratings/indicators/scores. If a rating is proven to be false, the rater will be marked as such, and this will impact his credibility and his score on SC. This will provide self-policing among members and users.

Various ratings of members carry various weight, and ultimately affect total SC credit score, in accordance to said weight. So, for example, a friendliness rating of 5 (out of 5, max, or highest) does not carry the same weight as a trustworthiness rating of 5.

All money transactions are to be done electronically throughout SC site, unless proof of any transactions verified by all parties is provided. For example, the borrower happens to be in the presence of lender at the time a payment is due, so he gives him cash and lender marks that payment as paid, on SC site, even though there is no electronic payment made (for one embodiment).

Scenario: Borrowers can post what they need to borrow, conditions they are willing to meet, collateral they offer, their current SC and conventional credit scores, their location, etc. Lenders can pick through and make offers based on the above information. The borrower can choose the best offer. Also, the lenders can post certain information about themselves to let potential borrowers know that they are open for business.

If a borrower falls behind on payments or repayment, because of a good reason or any reason, his social media contacts will be notified of the fact that he is late and why. Then, the friends will have an opportunity to make payments for him by chipping in whatever amount they can, to help him get through his difficulties, as an option, as an example.

SC system is better because the monies go directly to pay the debt, and it is your own circle of friends. Also, the debt could be any kind of debt. One example:

A government employee who is on furlough needs help with rent and car payment for one month. For the total of $1700.00, his Facebook friends can choose to either donate $50, or lend $50 to him through SC, until the $1700.00 is met. He cannot accept more than $1700.00, even though the total pledges are a lot more. Only the listed needs/debts get paid. (E.g., the borrower may need a bridge loan for his pocket money, as well.) However, he can opt to pick donation offers, over lending offers, if the total offerings are more than the total debt of $1700, as an option, as an example.

This invention, in one example, is for providing a framework and an environment of a self-policing society for a friendly way of sharing one's possessions with their peers where all well-intentioned parties as well as all good actors are protected and rewarded. This approach is intended to allow goodness to grow within the society, as we minimize and expose bad actors, by rewarding good behavior and punishing bad behavior.

Borrowers must list all their current debts. This list may or may not only be available to certain parties, in different embodiments. Any type of information on the SC site may or may not only be available for viewing to certain parties or by certain parties' permission, in different embodiments. In an embodiment, the line of credit/credit card is entirely operated by lender with or without some tools or help from SC, in different examples/situations.

SC may have a space where lenders can connect with independent legal advice. Or, legal advice is directly provided by SC, in different examples/situations. Reporting good or bad behavior, as agreed upon between parties, in contract, is one of the options in some examples/embodiments.

We disallow/prevent the borrower to shut his FB and the like, to avoid embarrassments, in one example. Also, such attempt triggers a red alert, sent to all. All the above/disclosure here applies to loans, credit cards, credit lines, and the like. Please note that when we refer to “his own circle of friends”, we can generalize that to any 3^{rd} party or investors or public or family or extended family. SC system can be used in lieu of the wire transfer, with one payment/zero interest rate, as a special case.

In one example, the money can be a loan or donation/grant, with no repayment, or combination of both. The designation can be by lender, with one or more parties, or the option be chosen later on, if any, by the borrower(s), or their team/group. So, they may or may not have these choices in various examples/embodiments. They can borrow up to the limit set or needed, and the money that is raised, if higher value than threshold, cannot be touched by the borrower, beyond the limit/threshold of the borrower, as pre-set before.

For example, maybe, 10K$ was raised in the pot/bucket, but the credit limit/withdrawal is limited to 2K$, only, up to that limit, total. Anything more than 2K$ stays in the bucket, and not accessible to borrower at this point, unless a new limit/contract is agreed upon, or some of the loan is forgiven by one or more members of syndicate of lender, as partial forgiveness or full forgiveness of the loan.

The borrower/lender can be an association, team, company, group, or syndicate, or as individual(s). The bucket/fund can be increased or collected in steps or in a period of time, as one example. This can be as revolving credit that goes up and down after each re-payments, or increases the threshold after good behavior/on-time payments/with higher scores/with collaterals/with co-signer(s).

This SC system could be on any device, mobile, phone, virtual, PC, remote, at edge, through Internet, secure network, table, tablet, server farm, server, pad, or the like. This could be inside, remote, nearby, in vicinity, with RFID, in line of sight, with infra-red communicator, with laser communicator, with one central computer, or server. This could be on separate computers, or server farm, or array of computers or processors, or communicating devices peer-to-peer, or centralized, or distributed, or parallel, or the like. This could be in real time or with delay process. Any memory or RAM/ROM or backup storage or flash memory or optical or magnetic device or buffer or hard drive or external drive can be used for this purpose. This could be in-device processing, or in mobile app, or in mobile device, or centralized, or remote processing, or distributed. In one embodiment, we have cloud computing, server farms, no-server, edge computing, single computer, mobile device, laptop, tel, watch, or IoT, or the like, for computing device. Any variations of the above teaching is also intended to be covered and protected by the current patent application. Any 2 or more embodiments can be combined or mixed, as well.

1. A method of credit analysis and credit offering, based on social media, said method comprising:
a first processor receiving name of a first person from a first social website;
said first processor receiving a first score for said first person related to said first social website, from said first social website;
wherein said first score for said first person related to said first social website is related to risk factor, reputation, reliability, credibility, and creditworthiness of said first person;
wherein said first score for said first person is obtained from a subset of members of said first social website who are directly connected to or befriended with said first person, based on said risk factor, reputation, reliability, credibility, and creditworthiness of said first person, produced through a second processor at said first social website;
a final score device getting a financial or bank score or another equivalent score from a bank or credit card company;
said final score device combining said financial or bank score or said another equivalent score from said bank or credit card company with said first score, to produce a first combined score for said first person;
an interest rate assigning device calculating a first interest rate based on said first combined score for said first person;
said first person registering with a second website for financial transactions, commerce, or e-commerce;
said first person accepting conditions and rules set by said second website on said second website;
wherein said accepted conditions and rules set by said second website comprises a consent by said first person for release of information and score regarding said first person, stored in a consent memory or storage;
said first person sending a request for a line of credit or loan through said second website;
wherein said line of credit or loan is based on one or more of following: cash, electronic money, e-currency, cryptocurrency, a tangible item or commodity, an intangible item or commodity, foreign currency, valuable material, precious or semi-precious material, stone, or metal, intellectual property, stock, an entity's credit, or a currency equivalent;
a second person or entity evaluating said request by said first person, regarding said line of credit or loan through said second website, based on said first combined score for said first person;
said second person or entity responding to said request by said first person, regarding said line of credit or loan through said second website;
wherein a third person is a friend of said first person in a said first social website;
said third person setting or changing parameters based on one or more rules in a template for a contract for said line of credit or loan;
said second person or entity setting or changing said parameters based on said one or more rules in said template for said contract for said line of credit or loan, as a first offer;
said first person setting or changing said parameters based on said one or more rules in said template for said contract for said line of credit or loan, as a first counter-offer;
said second person or entity and said first person repeating said first offer and said first counter-offer, back and forth in a negotiation manner, until both said first person and said second person or entity accept said parameters based on said one or more rules in said template for said contract for said line of credit or loan, as negotiated terms and conditions of said line of credit or loan, through said second website, based on said first interest rate;
said first person receiving said line of credit or loan, from said second person or entity, based on said first interest rate;
in case said first person attempts to block or unfriend any friend or family on said first social website, said first social website checking for said first person's consent in said consent memory or storage, and based on said first person's consent in said consent memory or storage, said first social website preventing said first person's attempt to block or unfriend any friend or family on said first social website;
said second processor calculating and updating said first combined score for said first person, based on performance of said first person on said received line of credit or loan, with respect to said negotiated terms and conditions of said line of credit or loan;
in case of default or late payment by said first person, a classifier assigning a severe tier status or degree associated with bad performance or behavior to said first person;
in case of on-time payment by said first person, said classifier assigning a low or non-severe tier status or degree associated with good performance or behavior to said first person;
in case of said severe tier status or degree for said first person, a reporting device assigning a distribution list of said first social website and a fifth social website;
in case of said low or non-severe tier status or degree for said first person, said reporting device assigning said distribution list of said first social website;
in case of said severe tier status or degree for said first person, said second processor reporting said updated first combined score for said first person and said performance of said first person on said received line of credit or loan, to said first social website and said fifth social website;
in case of said low or non-severe tier status or degree for said first person, said second processor reporting said updated first combined score for said first person and said performance of said first person on said received line of credit or loan, to some or selected members of said first social website.

2-3. (canceled)

4. The method of credit analysis and credit offering, based on social media, as recited in claim 1, said method comprises:
combining or supplementing a second score from a third social website with said first score.

5. The method of credit analysis and credit offering, based on social media, as recited in claim 1, said method comprises:
combining or supplementing a second score from a third social website and a third score from a fourth social website with said first score.

6. The method of credit analysis and credit offering, based on social media, as recited in claim 1, said method comprises:
reporting bad behavior, late payment, no payment, or default.

7. The method of credit analysis and credit offering, based on social media, as recited in claim 1, said method comprises:
reporting good behavior, on-time payment, early payment, or loan complete payoff.

8. The method of credit analysis and credit offering, based on social media, as recited in claim 1, said method comprises:
said first person consenting or agreeing to reporting good behavior and action or bad behavior or action to family and friends associated to said first social website.

9. The method of credit analysis and credit offering, based on social media, as recited in claim 1, said method comprises:
said first person consenting or agreeing to reporting good behavior and action or bad behavior or action to family and friends associated to said first social website and a third social website.

10. The method of credit analysis and credit offering, based on social media, as recited in claim 1, said method comprises:
said first person consenting or agreeing to not cancel or terminate said first person's account on said first social website.

11-16. (canceled)

17. The method of credit analysis and credit offering, based on social media, as recited in claim 1, said method comprises:
announcing or reporting bad or good behavior to different people, friends, or family members, at various times and time periods and at various scopes, based on severity or seriousness of said bad or good behavior or said bad or good behavior's tier or classification.

18. The method of credit analysis and credit offering, based on social media, as recited in claim 1, said method comprises:
appealing a decision regarding bad or good behavior to an arbitrator.

19. The method of credit analysis and credit offering, based on social media, as recited in claim 1, said method comprises:
rating a lender.

20. The method of credit analysis and credit offering, based on social media, as recited in claim 1, said method comprises:
vouching for a friend on said first social website.

21. The method of credit analysis and credit offering, based on social media, as recited in claim 1, said method comprises:
confirming identity of a friend on said first social website.

22. The method of credit analysis and credit offering, based on social media, as recited in claim 1, said method comprises:
co-signing a loan for or with a friend on said first social website.

23. The method of credit analysis and credit offering, based on social media, as recited in claim 1, said method comprises:
guaranteeing or backing up a loan for a friend on said first social website.

24. The method of credit analysis and credit offering, based on social media, as recited in claim 1, said method comprises:
connecting or introducing a friend to another friend on said first social website.

25. The method of credit analysis and credit offering, based on social media, as recited in claim 1, said method comprises:
rating, scoring, classifying, or commenting on a friend on said first social website.

26. The method of credit analysis and credit offering, based on social media, as recited in claim 1, said method comprises:
recommending a friend on said first social website to an entity or another friend.

27. The method of credit analysis and credit offering, based on social media, as recited in claim 1, said method comprises:
alerting or noticing others or stopping said first person, if said first person does not comply with rules or conditions that said first person consents or agrees to do or not to do, with respect to friend or family on said first social website.

28. The method of credit analysis and credit offering, based on social media, as recited in claim 1, said method comprises:
providing proof of a transaction, verified by all parties.

29. The method of credit analysis and credit offering, based on social media, as recited in claim 1, said method comprises:
providing money as a loan or donation, from an individual or from a group or syndicate;
setting a threshold for borrowing;
borrowing up to said threshold.

30. The method of credit analysis and credit offering, based on social media, as recited in claim 1, said method comprises:
applying or transferring fund for a loan, credit line, debit card, or credit card.
